(19) United States
(12) Patent Application Publication
(10) Pub. No.: US 2026/0045253 A1
(43) Pub. Date: Feb. 12, 2026

(54) Situationally Adaptive Speech Detection System

(71) Applicant: Disney Enterprises, Inc., Burbank, CA (US)

(72) Inventors: Maike Paetzel-Pruesmann, Zurich (CH); James R. Kennedy, Glendale, CA (US); Lanny S. Smoot, Thousand Oaks, CA (US); Hyewon Han, Seoul (KR); Komath Naveen Kumar, Los Angeles, CA (US); Michael Ilardi, Los Angeles, CA (US); Clare M. Carroll, Pasadena, CA (US)

(21) Appl. No.: 18/796,911

(22) Filed: Aug. 7, 2024

(51) Int. Cl. G10L 15/183; G10L 15/25; G10L 25/93

(52) U.S. Cl. CPC G10L 15/183; G10L 15/25; G10L 25/93

(57) ABSTRACT

A system includes a hardware processor and a memory storing software code and a natural language understanding (NLU) machine learning model. The hardware processor executes the software code to determine the proximity of a human in a venue to a microphone communicatively coupled to the system, activate the microphone before a start of speech by the human, in response to determining the proximity of the human being within a predetermined distance from the microphone, and detect an action by the human signifying an end of the speech. The software code is further executed to deactivate the microphone upon detecting the action to provide an audio recording including the speech, the audio recording beginning before the start of the speech and terminating at the end of the speech, determine, using the NLU machine learning model, that the speech includes an unwanted portion, and erase the unwanted portion of the audio recording.

### BACKGROUND

In large venues having interactive features, such as multiple virtual agents to which individual people or groups of people may address speech contemporaneously, multiple microphones may be situated throughout the venue in order to capture speech unobtrusively. However, because those microphones and human speakers exist in the same space, the microphones may pick up audio from all active human speakers in the space, resulting in crosstalk between microphone channels, the capture of private comments or conversations irrelevant to the interactions provided within the venue, and possible confusion during downstream processing by natural language understanding (NLU) systems. Moreover, as the number of microphones used to capture speech is increased it can become infeasible to have all microphones active at the same time if the downstream processing relies on Automatic Speech Recognition (ASR), while performing NLU and can incur unacceptably high computational, and cloud-based API usage costs.

One widely used technique for giving a human speaker control over which parts of their speech is transmitted to a technology system is known as push-to-talk, which employs a push button actuated device like a walkie-talkie. Between people and a technology system, including virtual agents, the push button controls whether speech is recorded and sent to the speech processing unit of the system. Apart from ensuring privacy, push-to-talk is often used to filter audio streams in multi-party interactions and ensure only relevant speech is transmitted over the device.

In the ideal case, the button in a push-to-talk setting is pushed down and held immediately before the human speaker begins to speak, and is released immediately after their utterance has ended. In reality, however, humans make errors when using this technology and can inadvertently cut off their own speech by pressing the button late or releasing it early, or they can transmit more speech than they intended to by pressing the button early or releasing it late. Human conversational partners in a person-to-person push-to-talk interaction can often recover from these errors because they can either infer missing parts of an utterance or understand that some received speech was not directed to them. In case of doubt, they can ask for clarification. Technology systems and virtual agents do not presently have the same predictive capabilities, and attempts to imbue them with such capabilities tend to undesirably incur significant latency. Thus, there is a need in the art for an automated solution for adaptively activating speech detection devices within an interactive venue so as to reduce crosstalk and the computational resources necessary to apply NLU to detected speech, while protecting the personal privacy of human speakers.

### BRIEF DESCRIPTION OF THE DRAWINGS

FIG. 1 shows an exemplary venue including a situationally adaptive speech detection system, according to one implementation;

FIG. 2 shows an exemplary venue including a situationally adaptive speech detection system, according to another implementation;

FIG. 3 shows two exemplary use cases of push-to-talk communications in which a late start or an early start to push button actuation occurs

FIG. 4 shows an exemplary venue including a situationally adaptive speech detection system, according to yet another implementation; and

FIG. 5 shows a flowchart presenting an exemplary method for use by a system to perform situationally adaptive speech detection, according to one implementation.

### DETAILED DESCRIPTION

The following description contains specific information pertaining to implementations in the present disclosure. One skilled in the art will recognize that the present disclosure may be implemented in a manner different from that specifically discussed herein. The drawings in the present application and their accompanying detailed description are directed to merely exemplary implementations. Unless noted otherwise, like or corresponding elements among the figures may be indicated by like or corresponding reference numerals. Moreover, the drawings and illustrations in the present application are generally not to scale, and are not intended to correspond to actual relative dimensions.

As stated above, in large venues having interactive features, such as multiple virtual agents to which individual people or groups of people may address speech contemporaneously, multiple microphones may be situated throughout the venue in order to capture speech unobtrusively. However, because those microphones and human speakers exist in the same space, the microphones may pick up audio from all active human speakers in the space, resulting in crosstalk between microphone channels, the capture of private comments or conversations irrelevant to the interactions provided within the venue, and possible confusion during downstream processing by natural language understanding (NLU) systems. Moreover, as the number of microphones used to capture speech is increased it can become infeasible to have all microphones active at the same time if the downstream processing relies on Automatic Speech Recognition (ASR), while performing NLU and can incur unacceptably high computational and cloud-based API usage costs.

As further stated above, one widely used technique for giving a human speaker control over which parts of their speech is transmitted to a technology system is known as push-to-talk, which employs a push button actuated device like a walkie-talkie. Between people and a technology system, including virtual agents, the push button controls whether speech is recorded and sent to the speech processing unit of the system. Apart from ensuring privacy, push-to-talk is often used to filter audio streams in multi-party interactions and ensure only relevant speech is transmitted over the device. Nevertheless, humans can make errors when using this technology and can inadvertently cut off their own speech by pressing the button late or releasing it early, or they can transmit more speech than they intended to by pressing the button early or releasing it late.

The present application discloses situationally adaptive speech detection systems and methods that address and overcome the drawbacks and deficiencies in the conventional art described above. The present situationally adaptive speech detection solution advances the state-of-the-art by adaptively activating speech detection devices within an interactive venue so as to reduce crosstalk and the computational resources necessary to apply NLU to detected speech, while protecting the personal privacy of human speakers. Moreover, the present situationally adaptive speech detection solution may advantageously be implemented as automated systems and method.

As used in the present application, the terms “automation,” “automated” and “automating” refer to systems and processes that do not require the participation of a human system operator. Although in some implementations the device activation strategy implemented by, and the speech detection performed using, the systems and methods disclosed herein may be reviewed or even modified by a human system operator, that human involvement is optional. Thus, the methods described in the present application may be performed under the control of hardware processing components of the disclosed systems.

In addition, as defined in the present application, a virtual agent refers to a non-human agent that exhibits behavior that can be perceived by a human whom interacts with the virtual agent as an autonomous entity. Virtual agents may be implemented so as appear to animate machines or other physical devices, such as robots or toys, or may be entirely virtual entities, such as digital characters presented by avatars or other animations on a screen, or disembodied voices emanating from an audio output device. Virtual agents may speak with their own characteristic voice (e.g., phonation, pitch, loudness, rate, dialect, accent, rhythm, inflection and the like). In various use cases, virtual agents may exhibit characteristics of living or historical characters, fictional characters from literature, film and the like, or simply unique individual entities that exhibit patterns that are recognizable by humans as a personality.

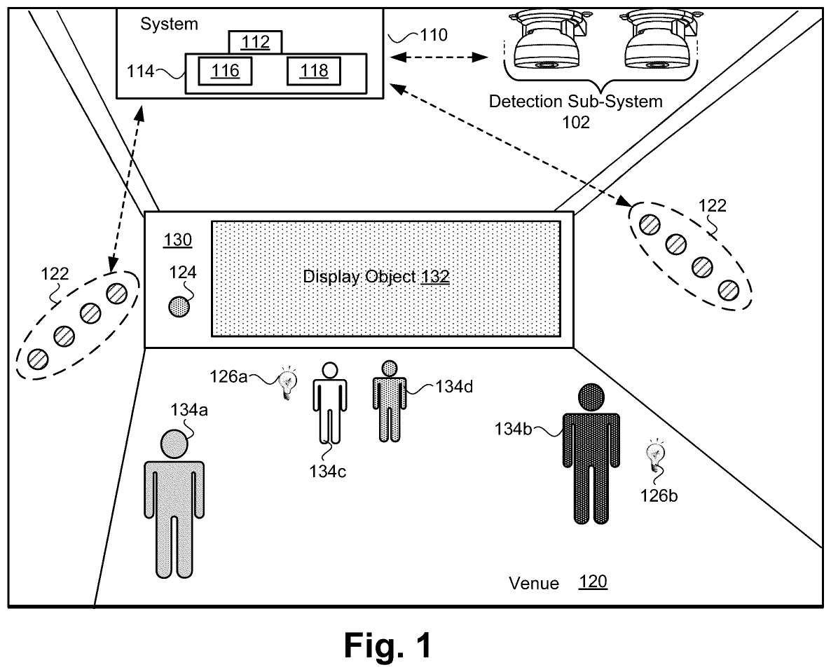

FIG. 1 shows exemplary venue 120 including situationally adaptive speech detection system 110 (hereinafter “system 110”), according to one implementation. As shown in FIG. 1, system 110 includes hardware processor 112, and memory 114 implemented as a computer-readable non-transitory storage medium containing software code 116 and natural language understanding (NLU) machine learning model 118. In addition, system 110 includes multiple microphones 122 situated within venue 120 and communicatively coupled to system 110, as well as, in some implementations, detection sub-system 102 also communicatively coupled to system 110.

It is noted that, as defined for the purposes of the present application, the expression “communicatively coupled” may mean physically integrated with, or physically discrete from but in communication with. Thus, one or more of microphones 122 and detection sub-system 102 may be integrated with system 110, or may be adjacent to or remote from system 110 while being in wired or wireless communication with computing system 110.

As further shown in FIG. 1, system 110 is implemented within venue 120 including exemplary interactive feature 130 including audio output device 124 and display object 132. Also shown in FIG. 1 are one or more humans 134a, 134b, 134c and 134d (hereinafter “human(s) 134a-134d”) present in venue 120, as well as optional lighting features 126a and 126b.

It is noted that interactive feature 130 may include a virtual agent depicted as an image of a character on display object 132, when display object 132 takes the form of a display screen. In some use cases, the virtual agent may appear to watch and listen to one or more of human(s) 134a-134d. Such a digital character may be depicted in content including digital representations of persons, fictional characters, locations, objects, and identifiers such as brands and logos, for example, which populate a virtual reality (VR), augmented reality (AR), or mixed reality (MR) environment. Moreover, that content may depict virtual worlds that can be experienced by any number of users synchronously and persistently, while providing continuity of data such as personal identity, user history, entitlements, possessions, payments, and the like. It is noted that in some implementations the content rendered on display object 132 may be a hybrid of traditional audio-video (AV) content and fully immersive VR/AR/MR experiences, such as interactive video.

Alternatively, or in addition, display object 132 may be a display screen playing a video loop of a natural phenomenon, such as a storm or volcanic eruption, or playing a movie, displaying a game environment, or displaying any other type of content. In use cases in which display object 132 is a display screen, display object 132 may take the form of a liquid crystal display (LCD), a light-emitting diode (LED) display, an organic light-emitting diode (OLED) display, a quantum dot (QD) display, or may be implemented using any other suitable display screen technology that performs a physical transformation of signals to light.

Alternatively, display object 132 may be a projection screen, rather than a display screen, onto which a video loop of a natural phenomenon, or a movie, a game environment, or any other type of content is projected. As yet another alternative, display object 132 may be or include a work of art, or a display of one or more jewels or relics for which descriptive narration is provided or questions from human(s) 134a-134d are responded to by a virtual agent acting as host of display object 132, via audio output device 124. Thus, according to the exemplary implementation shown in FIG. 1, venue 120 may be a physical venue in the form of a museum, a library, an art installation, or an auditorium, to name a few examples.

It is further noted that although FIG. 1 depicts venue 120 as including single interactive feature 130, that representation is provided merely in the interests of conceptual clarity. More generally, it is contemplated that venue 120 includes at least several interactive features corresponding to interactive feature 130, and in some implementations may include dozens of interactive features corresponding to interactive feature 130.

Referring to system 110, memory 114 may take the form of any computer-readable non-transitory storage medium. The expression “computer-readable non-transitory storage medium,” as defined in the present application, refers to any medium, excluding a carrier wave or other transitory signal, that provides instructions to hardware processor 112 of system 110. Thus, a computer-readable non-transitory medium may correspond to various types of media, such as volatile media and non-volatile media, for example. Volatile media may include dynamic memory, such as dynamic random access memory (dynamic RAM), while non-volatile memory may include optical, magnetic, or electrostatic storage devices. Common forms of computer-readable non-transitory storage media include, for example, optical discs, RAM, programmable read-only memory (PROM), erasable PROM (EPROM), and FLASH memory.

Moreover, in some implementations, system 110 may utilize a decentralized secure digital ledger in addition to memory 114. Examples of such decentralized secure digital ledgers may include a blockchain, hashgraph, directed acyclic graph (DAG), and Holochain® ledger, to name a few. In use cases in which the decentralized secure digital ledger is a blockchain ledger, it may be advantageous or desirable for the decentralized secure digital ledger to utilize a consensus mechanism having a proof-of-stake (POS) protocol, rather than the more energy intensive proof-of-work (PoW) protocol.

Although FIG. 1 depicts software code 116 and NLU machine learning model 118 as being co-located in a single instance of memory 114, that representation is merely provided as an aid to conceptual clarity. More generally, system 110 may include one or more computing platforms, such as computer servers for example, which may be co-located, or may form an interactively linked but distributed system, such as a cloud-based system, for instance. As a result, hardware processor 112 and memory 114 may correspond to distributed processor and memory resources within system 110. Consequently, in some implementations, software code 116 and NLU machine learning model 118 may be stored remotely from one another on the distributed memory resources of system 110.

Hardware processor 112 may include multiple hardware processing units, such as one or more central processing units, one or more graphics processing units, and one or more tensor processing units, one or more field-programmable gate arrays (FPGAs), custom hardware for machine-learning training or inferencing, and an application programming interface (API) server, for example. By way of definition, as used in the present application, the terms “central processing unit” (CPU), “graphics processing unit” (GPU), and “tensor processing unit” (TPU) have their customary meaning in the art. That is to say, a CPU includes an Arithmetic Logic Unit (ALU) for carrying out the arithmetic and logical operations of system 110, as well as a Control Unit (CU) for retrieving programs such as software code 116 from memory 114, while a GPU may be implemented to reduce the processing overhead of the CPU by performing computationally intensive graphics or other processing tasks. A TPU is an application-specific integrated circuit (ASIC) configured specifically for artificial intelligence (AI) applications such as ML modeling.

It is noted that, as defined in the present application, the expression “machine learning model” refers to a computational model for making predictions based on patterns learned from samples of data (i.e., training data). Various learning algorithms can be used to map correlations between input data and output data. These correlations form the computational model that can be used to make future predictions on new input data. Such a predictive model may include one or more logistic regression models, Bayesian models, or artificial neural networks (NNs), Transformer-based models, large-language models, multimodal foundation models, as well as various classical AI models, to name a few examples. Moreover, a “deep neural network,” in the context of deep learning, may refer to an NN that utilizes multiple hidden layers between input and output layers, which may allow for learning based on features not explicitly defined in raw data. As used in the present application, any feature identified as an NN refers to a deep neural network.

In some implementations, system 110 may correspond to one or more web servers, accessible over a packet-switched network such as the Internet, for example. Alternatively, system 110 may correspond to one or more computer servers supporting a private wide area network (WAN), local area network (LAN), or included in another type of limited distribution or private network. In addition, or alternatively, in some implementations, system 110 may utilize a local area broadcast method, such as User Datagram Protocol (UDP) or Bluetooth®, for instance to communicate with microphones 122 and with detection sub-system 102. Furthermore, in some implementations, system 110 may be implemented virtually, such as in a data center. For example, in some implementations, system 110 may be implemented in software, or as virtual machines.

Detection sub-system 102 may include a camera, camera array, or one or more other types of optical sensors for determining the locations and actions of human(s) 134a-134d as human(s) 134a-134d move around in venue 120. For example, in some implementations detection sub-system 102 may include one or more infrared (IR) cameras, such as long wave IR cameras (heat cameras). As another alternative, or in addition, detection sub-system 102 may include multiple directional microphones, or multiple components distributed within venue 120 and configured to perform beamforming, to determine the locations of human(s) 134a-134d.

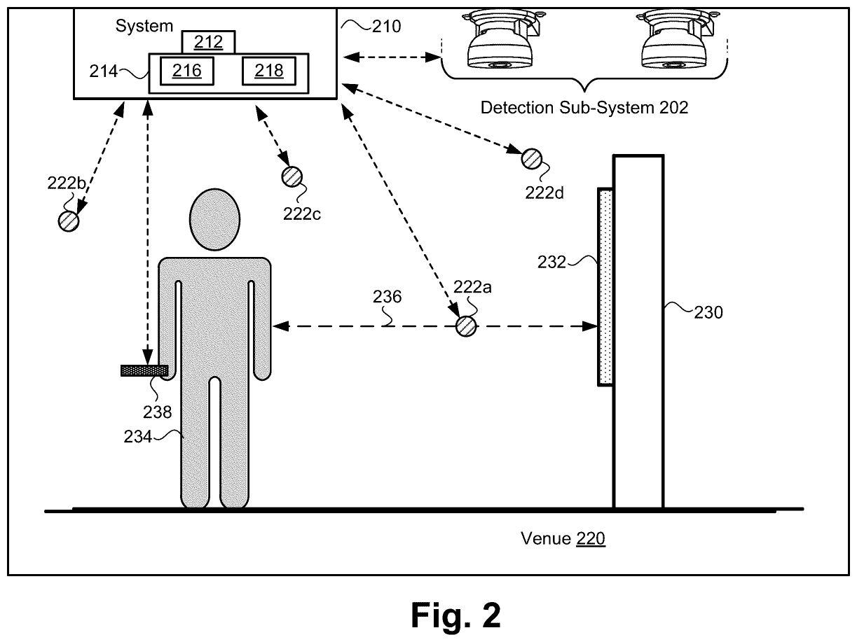

FIG. 2 shows venue 220 including situationally adaptive speech detection system 210 (hereinafter “system 210”), according to another implementation. As shown in FIG. 2, system 210 includes hardware processor 212, and memory 214 implemented as a computer-readable non-transitory storage medium containing software code 216 and NLU machine learning model 218. In addition, system 210 includes multiple microphones 222a, 222b, 222c and 222d (hereinafter “microphones 222a-222d”) situated within venue 220 and communicatively coupled to system 210, as well as, in some implementations, detection sub-system 202 also communicatively coupled to system 210.

As further shown in FIG. 2, system 210 is implemented within venue 220 having exemplary interactive feature 230 including display object 232. Also shown in FIG. 2 is human 234 present in venue 220, handheld communication device 238 in the form of an exemplary push-to-talk device (hereinafter “push-to-talk device 238”) enabling human 234 to initiate and terminate voice communication by human 234 with interactive feature 230 at will, as well as predetermined distance 236.

System 210 including hardware processor 212 and memory 214 storing software code 216 and NLU machine learning model 218 corresponds in general to system 110 including hardware processor 112 and memory 114 storing software code 116 and NLU machine learning model 118, in FIG. 1. Consequently, system 210, hardware processor 212, memory 214, software code 216 and NLU machine learning model 218 may share any of the characteristics attributed to respective system 110, hardware processor 112, memory 114, software code 116 and NLU machine learning model 118 by the present disclosure, and vice versa. In addition, microphones 222a-222d and detection sub-system 202, in FIG. 2, correspond respectively in general to microphones 122 and detection sub-system 102, in FIG. 1. Thus, microphones 222a-222d and detection sub-system 202 may share any of the characteristics attributed to respective microphones 122 and detection sub-system 102, and vice versa.

Moreover, venue 220 having interactive feature 230 including display object 232, and human 234 present in venue 220, in FIG. 2, correspond respectively in general to venue 120 having interactive feature 130 including display object 132, and any one of human(s) 134a-134d present in venue 120, in FIG. 1. Accordingly, venue 220, interactive feature 230, display object 232 and human 234 may share any of the characteristics attributed to respective venue 120, interactive feature 130, display object 132 and any of human(s) 134a-134d, and vice versa.

With respect to the apparent proximity of human 234 to microphones 222a-222d, it is noted that microphones 222b, 222c and 222d appear to be closer to human 234 than they really are due to the rendering of the three-dimensional space of venue 220 on the two-dimensional surface of the drawing sheet of FIG. 2. Thus, despite appearances, human 234 is located within predetermined distance 236 of microphone 222a, but is located farther than predetermined distance 236 of each of microphones 222b, 222c and 222d.

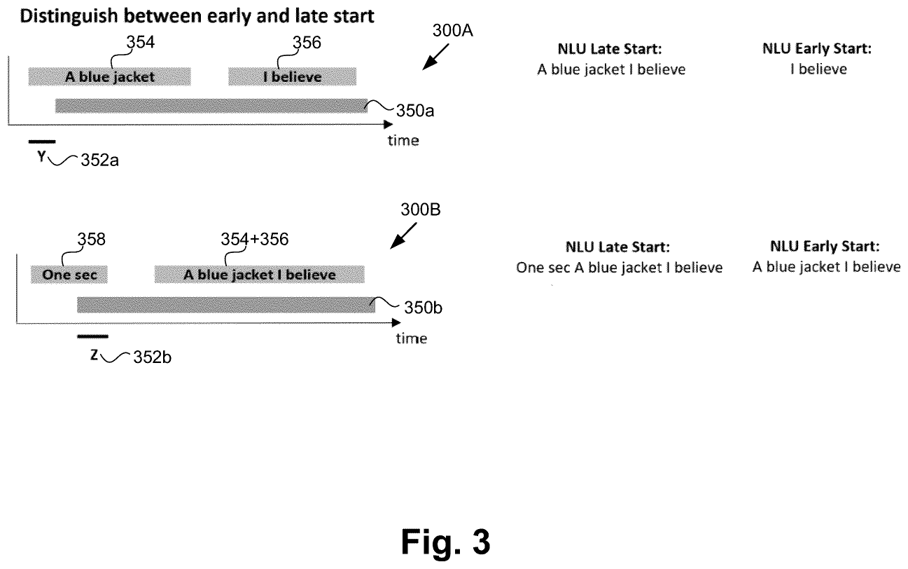

FIG. 3 shows two exemplary use cases of push-to-talk communications in which a late start or an early start to push button actuation occurs. In use case 300A, button push 350a occurs prior to phrase 354 “A blue jacket,” and button push 350a is released after the end of phrase 356 “I believe.” Consequently, and referring to FIGS. 2 and 3 in combination, according to conventional push-to-talk technology the entire speech “A blue jacket I believe” (phrase 354+356) is interpreted to be the intended speech by human 234 using push-to-talk device 238. However, and as is apparent from use case 300A, phrase 354 “A blue jacket” began to be uttered prior to button push 350a. As a result, a question remains as to whether button push 350a occurred late and the speech intended to be transmitted by human 234 is the entirety of phrase 354+356 “A blue jacket I believe,” or whether button push 350a occurred early and human 234 intended to transmit only phrase 356 “I believe.”

In use case 300B, button push 350b occurs in the middle of phrase 358 “One see,” and button push 350b is released after the end of phrase 354+356 “A blue jacket I believe.” Consequently, and referring to FIGS. 2 and 3 in combination, according to conventional push-to-talk technology only the nonsense language “sec A blue jacket I believe” is interpreted to be the intended speech by human 234 using push-to-talk device 238. However, and as is apparent from use case 300B, phrase 358 “One sec” began to be uttered prior to button push 350b. As a result, a question remains as to whether button push 350b occurred late and the speech intended to be transmitted by human 234 is the entirety of phrase 358 and phrase 354+356 “One sec A blue jacket I believe,” or whether button push 350b occurred early and human 234 intended to transmit only phrase 354+356 “A blue jacket I believe.”

Instead of only processing audio when the button of push-to-talk device 238 is pressed down, the present situationally adaptive speech detection solution processes audio continuously when human 234 is present within predetermined distance 236 of one of microphones 222a-222d and keeps a buffer of previous incoming audio that was not yet marked as completed in an internal buffer. Once system 210 has marked an utterance as complete and the push button of push-to-talk device 238 is still in a released state, the buffer is cleared.

In instances in which human 234 presses the button of push-to-talk device 238 while in the middle of an ongoing speech, system 210 needs to take the decision to (i) disregard the entire speech as it was likely not intended to be transmitted to the system (e.g., early start), or (ii) accept the entire speech (including one or more phrases spoken before the button push-to-talk device 238 was pressed) for processing (e.g., late start). This decision can be made using multiple techniques including predetermined time intervals, automatically learned time intervals, and content interpretation. For example, and continuing to refer to FIGS. 2 and 3 in combination, using a predetermined time interval as a decision criterion, if button press 350a of push-to-talk device 238 was pressed after less than Y seconds (time interval 352a) of speech were recorded in the buffer, a late start may be determined and phrases 354 and 356 may both be processed as the intended speech by human 234. Alternatively, if phrase 358 was marked completed less than Z seconds (time interval 352b) after button press 350b of push-to-talk device 238, an early start may be determined and phrase 358 may be considered an unwanted portion of speech and may be disregarded for processing. As yet another alternative, if the push button of push-to-talk device 238 is both pressed and released during a short predetermined time interval, it may be determined that no speech was intended and no recorded phrases are processed or retained.

In some implementations, time intervals 352a and 352b may not be manually predetermined but may be automatically learned by system 210 from a set of data to pick optimal margins for detecting an early and late start in a given situation, i.e., time intervals 352a and 352b may be situationally adaptive time intervals. In other implementations, instead of a time interval-based determination, the determination as to what portions of speech to process may be content-based. For example, system 210 could process different numbers of sequential phrases in parallel, assign intents and then use a heuristic like higher intent assignment confidence or intent at a given context to decide which version of speech to continue with in downstream processing.

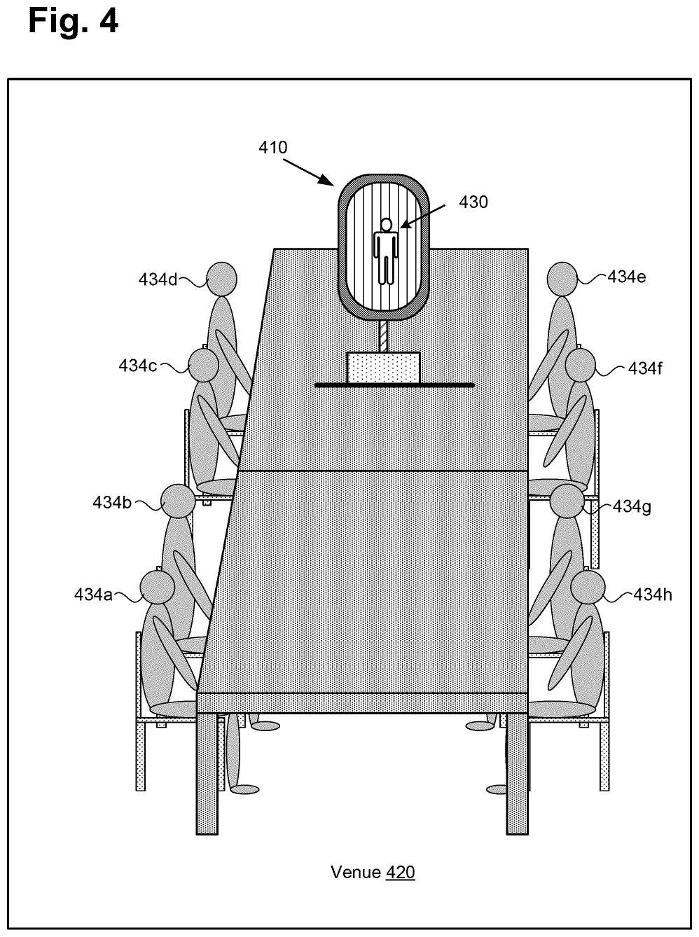

FIG. 4 shows venue 420 including situationally adaptive speech detection system 410 (hereinafter “system 410”), according to yet another implementation. According to the exemplary implementation shown in FIG. 4, system 410 includes interactive feature 430 in the form of a teleconferencing display screen. Also shown in FIG. 4 are teleconference attendee humans 434a, 434b, 434c, 434d, 434e, 434f, 434g and 434h (hereinafter humans 434a-434h″). Thus, and as depicted in FIG. 4, in some implementations venue 420 may be a conference room.

System 410, venue 420, interactive feature 430 and humans 434a-434h correspond respectively in general to system 110, venue 120, interactive feature 130 and human(s) 134a-134d, in FIG. 1. Consequently, system 410, venue 420, interactive feature 430 and humans 434a-434h may share any of the characteristics attributed to respective system 110, venue 120, interactive feature 130 and human(s) 134a-134d by the present disclosure, and vice versa. Thus, although not shown in FIG. 4, like system 110, system 410 includes features corresponding respectively to hardware processor 112, memory 114 implemented as a computer-readable non-transitory storage medium containing software code 116 and NLU machine learning model 118, microphones 122 situated within venue 420 and communicatively coupled to system 410, as well as, in some implementations, detection sub-system 102 also communicatively coupled to system 410.

It is noted that although FIGS. 1, 2 and 4 depict each of respective venues 120, 220 and 420 as a physical venue such as a museum, a library, an art installation, a conference room, or an auditorium, for example, those representations are merely provided as examples. In other implementations, a venue corresponding in general to any of venues 120, 220, or 420 may be a virtual venue. By way of example, in some implementations such a virtual venue may be a metaverse or a video game environment.

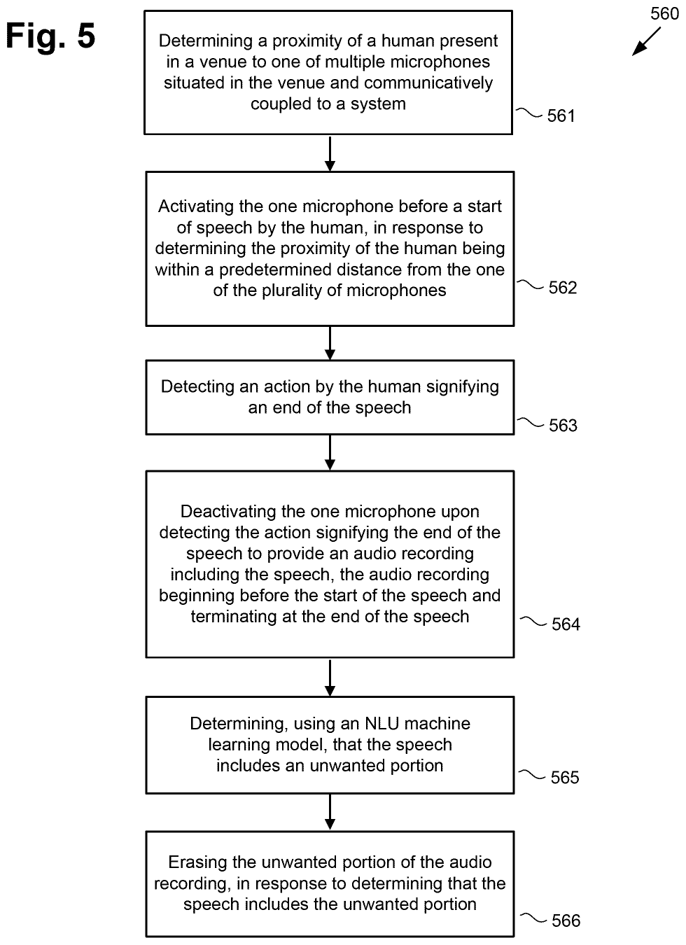

The functionality of systems 110/210/410 will be further described by reference to FIG. 5. FIG. 5 shows flowchart 560 presenting an exemplary method for use by a system to perform situationally adaptive speech detection, according to one implementation. With respect to the method outlined in FIG. 5, it is noted that certain details and features have been left out of flowchart 560 in order not to obscure the discussion of the inventive features in the present application.

Referring to FIG. 5, with further reference to FIG. 2, flowchart 560 includes determining a proximity of human 234 present in venue 220 to microphone 222a of multiple microphones 222a-222d situated in venue 220 and communicatively coupled to system 210 (action 561). In some implementations, determining the proximity of human 234 to microphone 222a may be performed based at least in part on context information regarding an organized activity or event occurring in venue 220, such as a guided or self-guided tour, scavenger hunt, or other multi-party game using venue 220 as the game environment. If there is prior knowledge of how the activity flows through the space of venue 220, that knowledge can be used to determine the proximity of human 234 to microphone 222a by predicting that proximity based on the anticipated activity flow within venue 220.

Furthermore, if there is foreknowledge of where different humans might be located within venue 220, different nudges can be used to ensure proximity of humans to only certain microphones. Referring to FIGS. 1 and 2 in combination, examples of such nudges might be using one or more of optional lighting features 126a and 126b as spotlights, or using a physical animatronics or gaze behavior that indicates who the intended recipient of an interaction with interactive feature 130/230 is. In addition, or alternatively, other opportunistic proximity determination techniques maybe include listening to active microphones placed at a lower level versus higher level to listen to adults and children participating in the activity taking place in venue 120/220.

It is noted that the proximity determination strategies described above assume prior knowledge of the activity taking place within venue 220 and the probable locations of humans within venue 220 as a result. In use cases where that knowledge is unavailable, sensors included in detection sub-system 202 can be used to determine the proximity of human 234 to microphone 222a. Examples of such systems could include (i) energy or direction-of-arrival based heuristics to determine which devices might be active, (ii) visual light camera based detection of active speakers by observing face or body motion and correlating information with the known physical layout of microphones, (iii) the use of long wavelength IR cameras (heat cameras), (iv) use of a single heat camera with a wide-angle observation capability to monitor the instantaneous locations of multiple humans over a wide area, (v) the use of conventional Schlieren, or laser-based Schlieren techniques to detect the hot air emitted by a human who is speaking, and (vi) the use of pre-trained audio machine learning models to consider raw information from audio channels to determine which channels are active and which are merely experiencing crosstalk, to name a few. Determining the proximity of human 234 present in venue 220 to microphone 222a, in action 561, may be performed by software code 216, executed by hardware processor 212 of system 210, and, in some implementations using detection sub-system 202.

By way of example, in some implementations a long wavelength IR camera (heat camera) may be used to detect the volume of heated air emitted by human 234 while human 234 is speaking, and a predetermined volume threshold may be used to determine that human 234 is intentionally speaking. Alternatively, or in addition, where a long wavelength IR camera is pointed at the face of human 234 (and likely aligned with the microphone 222a pointing direction), where the mouth and surrounding face area of human 234 are visible, and where the IR camera detects when the mouth of human 234 is open by determining the difference between the ambient external temperature of the face of human 234 and the (much higher) internal temperature of the mouth of human 234 as the mouth of human 234 is exposed (i.e., open). In use cases in which the area of high temperature detected by the heat camera exceeds a threshold indicating a large opening of the mouth, intentional speech directed at microphone 222a is indicated, as opposed to private conversation in which the face of human 234 is not directed at microphone 222a, or where the mouth openings are small, and the speech is not intended to be heard by microphone 222a.

As another alternative, or in addition, an ordinary visible light camera, facing in the same direction as microphone 222a (i.e., towards human 234) may be used and facial feature recognition may be employed to determine that the mouth of human 234 is moving in a way that indicates that human 234 is purposely speaking so as to be heard by microphone 222a.

As yet another alternative, or in addition, a Schlieren optical system capable of detecting the air pattern movement caused by the heated air emitted by a speaking person can be used to determine that human 234 is speaking. In the case of this detection method, the Schlieren optical system would need to be placed in front of, and orthogonal to human 234 because human 234 must speak across the optical detection path of a Schlieren optical system, which includes an optical emitter and a distance detector. Detection in this implementation indicates that human 234 must be facing in the direction in which their breath disturbs the air passing crosswise through the detection area of the Schlieren optical system, thereby advantageously determining both that human 234 is speaking and that human 234 is facing microphone 222a.

Continuing to refer to FIGS. 2 and 5 in combination, flowchart 560 further includes activating microphone 222a before a start of speech by human 234, in response to determining that the proximity of human 234 to microphone 222a is within predetermined distance 236 from microphone 222a (action 562). As noted above, the determination of the proximity of human 234 to microphone 222a could be based on predictions made using known activity flows through venue 220, based on sensor data generated by detection sub-system 202, or both.

In some implementations, activation of microphone 222a, in action 562, results in deactivation of one or more active microphones of multiple microphones 222b, 222c and 222d. Referring to FIG. 1 in combination with FIGS. 2 and 5, in some implementations, venue 120/220 may be occupied by multiple other humans 134a-134d speaking contemporaneously, where only those microphones of multiple microphones 122/222b/222c/222d to which any of other humans 134a-134d are determined to be within predetermined distance 236 from are activated. Referring once again to FIGS. 2 and 5 in combination, the activation of microphone 222a in response to determining that the proximity of human 234 to microphone 222a is within predetermined distance 236 from microphone 222a, in action 562, may be performed by software code 216, executed by hardware processor 212 of system 210.

Continuing to refer to FIGS. 2 and 5 in combination, flowchart 560 further includes detecting an action by human 234 signifying an end of the speech (action 563). In some use cases, as depicted in FIG. 2, the speech by human 234 may be received by system 210 as a transmission by push-to-talk device 238 carried by human 234. In those use cases, the action by human 234 signifying the end of the speech, detected in action 563, may terminate the transmission from push-to-talk device 238 as a result of release of the push button by human 234.

Alternatively, the action by human 234 signifying the end of the speech may be a pause in the speech, affirmative language indicating that the speech is ended, or silence by human 234 signifying cessation of speech. In some of those use cases, the action by human 234 signifying the end of the speech may be detected in action 253 using microphone 222a. Alternatively, the action by human 234 signifying the end of the speech, such as a cessation of speech by human 234, may be detected by one or more of visual light cameras included in detection sub-system 202, one or more long wavelength IR cameras capable of detecting heat expelled from the mouth of human 234 during speech, or using Schlieren imaging techniques. Detection of the action by human 234 signifying the end of the speech by human 234 may be performed by software code 216, executed by hardware processor 212 of system 210, and based on one or more inputs received from push-to-talk device 238, microphone 222a, or detection sub-system 202.

Continuing to refer to FIGS. 2 and 5 in combination, flowchart 560 further includes deactivating microphone 222a upon detecting the action signifying the end of the speech, in action 563, to provide an audio recording including the speech, the audio recording beginning before the start of the speech and terminating at the end of the speech (action 564). According to the present novel and inventive concepts, instead of only processing audio when the button of push-to-talk device 238 is pressed down, or when human 234 begins to speak as part of an interaction with interactive feature 230 of venue 220, the situationally adaptive speech detection solution disclosed herein processes audio continuously when human 234 is present within predetermined distance 236 of microphone 222a and keeps a buffer of previous incoming audio that was not yet marked as completed in an internal buffer. Thus, the audio recording provided in action 564 may undesirably include comments or conversation that are not relevant to the interaction by human 234 with interactive feature 230. Deactivation of microphone 222a to provide the audio recording beginning before the start of the speech and terminating at the end of the speech, in action 564, may be performed by software code 216, executed by hardware processor 212 of system 210.

Continuing to refer to FIGS. 2 and 5 in combination, flowchart 560 further includes determining, using NLU machine learning model 218, that the speech captured by the audio recording provided in action 564 includes an unwanted portion (action 565). As noted above by reference to action 564, because the audio recording provided in action 564 begins before speech relevant to an interaction with interactive feature 230 of venue 220 begins, that audio recording may include an unwanted portion including comments or conversation that are not relevant to the interaction by human 234 with interactive feature 230. That is to say, in some use cases, the unwanted portion of the audio recording may include one or more of a private conversation of human 234 with another human, and a private comment by human 234.

The determination as to whether the audio recording provided in action 564 includes an unwanted portion can be made using multiple techniques including predetermined time intervals, automatically learned time intervals, and content interpretation, for example. In a push-to-talk use case for instance, as discussed above by reference to FIGS. 2 and 3, and using a predetermined time interval as a decision criterion, if button press 350a of push-to-talk device 238 was pressed after less than Y seconds (time interval 352a) of speech were recorded in the buffer, a late start may be determined and phrases 354 and 356 may both be processed as the intended speech by human 234. Alternatively, if phrase 358 was marked completed less than Z seconds (time interval 352b) after button press 350b of push-to-talk device 238, an early start may be determined and phrase 358 may be considered an unwanted portion of speech and may be disregarded for processing. As yet another alternative, if the push button of push-to-talk device 238 is both pressed and released during a short predetermined time interval, it may be determined that no speech was intended and no recorded phrases are processed or retained. In some implementations, time intervals 352a and 352b may not be manually predetermined but may be automatically learned by NLU machine learning model 218 of system 210 from a set of data to pick optimal margins for detecting an early and late start in a given situation, i.e., time intervals 352a and 352b may be situationally adaptive time intervals.

In other implementations, including use cases that do not include push-to-talk technology, instead of a time interval-based determination, the determination as to what portions of speech are unwanted may be content-based. For example, NLU machine learning model 218 could be executed to process different numbers of sequential phrases in parallel, assign intents and then use a heuristic like higher intent assignment confidence or intent at a given context to decide which version of speech to continue with in downstream processing and what portion of the audio recording provided in action 564 is unwanted. Action 565 may be performed by software code 216, executed by hardware processor 212 of system 210, and using NLU machine learning model 218.

Continuing to refer to FIGS. 2 and 5 in combination, flowchart 560 further includes erasing the unwanted portion of the audio recording provided in action 564, in response to determining that the speech includes the unwanted portion (action 566). It is emphasized that the objective of system 210 is to accurately detect speech by human 234 that is relevant to an interaction by human 234 with interactive features of venue 220, while both minimizing the computational burden required to apply NLU to that relevant speech and protecting the privacy of human 234. As such, any private comments or communications, as well as any personally identifiable information (PII) of human 234 are unwanted. Thus, any information describing the age, gender, race, ethnicity, or any other PII of human 234 included in the speech captured by the audio recording provided in action 564 will typically be erased in action 566. Erasure to the unwanted portion of the audio recording provided in action 564 may be performed by software code 216, executed by hardware processor 212 of system 210.

Referring to FIGS. 1, 2, 4 and 5 in combination, it is noted that, with respect to the method outlined by flowchart 560, actions 561, 562, 563, 564, 565 and 566 may be performed as an automated process from which human participation, other than the speech by one or more of human(s) 134a-134d/234/434a-434h, may be omitted.

Thus, the present application discloses situationally adaptive speech detection systems and methods. The present situationally adaptive speech detection solution advances the state-of-the-art by adaptively activating speech detection devices within an interactive venue so as to reduce crosstalk and the computational resources necessary to apply NLU to detected speech, while protecting the personal privacy of human speakers.

From the above description it is manifest that various techniques can be used for implementing the concepts described in the present application without departing from the scope of those concepts. Moreover, while the concepts have been described with specific reference to certain implementations, a person of ordinary skill in the art would recognize that changes can be made in form and detail without departing from the scope of those concepts. As such, the described implementations are to be considered in all respects as illustrative and not restrictive. It should also be understood that the present application is not limited to the particular implementations described herein, but many rearrangements, modifications, and substitutions are possible without departing from the scope of the present disclosure.

What is claimed is:

1. A system comprising:
a hardware processor; and
a memory storing a software code and a natural language understanding (NLU) machine learning model;
the hardware processor configured to execute the software code to:
determine a proximity of a human present in a venue to one of a plurality of microphones situated in the venue and communicatively coupled to the system;
activate the one of the plurality of microphones before a start of speech by the human, in response to determining the proximity of the human being within a predetermined distance from the one of the plurality of microphones;
detect an action by the human signifying an end of the speech;
deactivate the one of the plurality of microphones upon detecting the action signifying the end of the speech to provide an audio recording including the speech, thereby the audio recording beginning before the start of the speech and terminating at the end of the speech;
determine, using the NLU machine learning model, that the speech includes an unwanted portion; and
erase the unwanted portion of the audio recording, in response to determining that the speech includes the unwanted portion.

2. The system of claim 1, wherein the unwanted portion of the audio recording includes at least one of a private comment by the human or a private conversation of the human with another human.

3. The system of claim 1, wherein the speech is received by the system as a transmission by a push-to-talk device carried by the human and wherein the action signifying the end of the speech terminates the transmission.

4. The system of claim 1, wherein the action signifying the end of the speech is one of a pause in the speech or the end of the speech.

5. The system of claim 1, wherein the system includes at least one camera, and wherein the speech is detected using the at least one camera.

6. The system of claim 5, wherein the at least one camera comprises a visible light camera aligned with the one of the plurality of microphones, wherein facial feature recognition is used to determine that the a mouth of the human is moving in a way that indicates that the human is purposely speaking so as to be heard by the one of the plurality of microphones.

7. The system of claim 5, wherein the at least one camera comprises a long wavelength infrared (IR) camera used to detect a volume of heated air emitted by the human while speaking, and wherein a predetermined volume threshold is used to determine that the human is intentionally speaking.

8. The system of claim 5, wherein the at least one camera comprises a long wavelength IR camera aligned with the one of the plurality of microphones, wherein the long wavelength IR camera is used to detect when the human is speaking by determining a difference between an ambient external temperature of a face of the human and an internal temperature of a mouth of the human when the mouth of the human is open.

9. The system of claim 8, wherein the internal temperature of the mouth of the human and a predetermined temperature threshold are used to determine whether the speech is being intentionally directed at the one of the plurality of microphones by the human.

10. The system of claim 1, wherein the system includes a Schlieren optical system, and wherein the speech is detected using the Schlieren optical system.

11. The system of claim 1, wherein activation of the one of the plurality of microphones results in deactivation of at least one other active microphone of the plurality of microphones.

12. The system of claim 1, wherein the venue is occupied by a plurality of other humans speaking contemporaneously, and wherein only those microphones of the plurality of microphones to which any of the plurality of other humans are determined to be within the predetermined distance from are activated.

13. The system of claim 1, wherein the venue is a physical venue in the form of one of a museum, a library, an art installation, a conference room, or an auditorium.

14. The system of claim 1, wherein the venue is a virtual venue in the form of one of a metaverse or a video game environment.

15. A method for use by a system including a hardware processor, and a memory storing a software code and a natural language understanding (NLU) machine learning model, the method comprising:
determining, by the software code executed by the hardware processor, a proximity of a human present in a venue to one of a plurality of microphones situated in the venue and communicatively coupled to the system;
activating the one of the plurality of microphones, by the software code executed by the hardware processor, before a start of speech by the human, in response to determining the proximity of the human being within a predetermined distance from the one of the plurality of microphones;
detecting, by the software code executed by the hardware processor, an action by the human signifying an end of the speech;
deactivating the one of the plurality of microphones, by the software code executed by the hardware processor, upon detecting the action signifying the end of the speech to provide an audio recording including the speech, thereby the audio recording beginning before the start of the speech and terminating at the end of the speech;
determining, by the software code executed by the hardware processor and using the NLU machine learning model, that the speech includes an unwanted portion; and
erasing the unwanted portion of the audio recording, by the software code executed by the hardware processor, in response to determining that the speech includes the unwanted portion.

16. The method of claim 15, wherein the unwanted portion of the audio recording includes at least one of a private comment by the human or a private conversation of the human with another human.

17. The method of claim 15, wherein the speech is received by the system as a transmission by a push-to-talk device carried by the human and wherein the action signifying the end of the speech terminates the transmission.

18. The method of claim 15, wherein the action signifying the end of the speech is one of a pause in the speech or the end of the speech.

19. The method of claim 15, wherein the system includes at least one camera, and wherein the speech is detected using the at least one camera.

20. The method of claim 15, further comprising:
deactivating, by the software code executed by the hardware processor in response to activating the one of the plurality of microphones, at least one other active microphone of the plurality of microphones.

21. The method of claim 15, wherein the venue is occupied by a plurality of other humans speaking contemporaneously, and wherein only those microphones of the plurality of microphones to which any of the plurality of other humans are determined to be within the predetermined distance from are activated.

22. The method of claim 15, wherein the venue is a physical venue in the form of one of a museum, a library, an art installation, a conference room, or an auditorium.

23. The method of claim 15, wherein the venue is a virtual venue in the form of one of a metaverse or a video game environment.
